(19) United States
(12) Patent Application Publication
(10) Pub. No.: US 2023/0316037 A1
(43) Pub. Date: Oct. 5, 2023

(54) System and Method for Training Artificial Intelligence Tradable Assets to Replicate a Specific Person or Group of People

(71) Applicant: David Kebudi, New York City, NY (US)

(72) Inventor: David Kebudi, New York City, RI (US)

(73) Assignee: Imitation Labs Inc., New York City, NY (US)

(21) Appl. No.: 18/329,514

(22) Filed: Jun. 5, 2023

Related U.S. Application Data
(60) Provisional application No. 63/350,010, filed on Jun. 7, 2022.

(51) Int. Cl. G06N 3/006; A63F 13/67; A63F 13/77; A63F 13/79

(52) U.S. Cl. CPC G06N 3/006; A63F 13/67; A63F 13/77; A63F 13/79; A63F 2300/8082

(57) ABSTRACT

The present invention relates to systems and methods for training artificial intelligence assets. The system comprises a digital market module that facilitates the acquisition of a bot from a digital market. A game module enables a user to play a game using the acquired bot. A training module is configured to train the bot through game play against one or more players, employing a mimicry technique. A feedback module obtains training data on the bot's performance in the game, capturing characteristics of the game play, and stores the data in metadata or a database. The system offers an efficient and effective approach to train artificial intelligence assets in the context of gaming, allowing for improved performance and adaptability based on real-time user interactions.

### CROSS-REFERENCE TO RELATED APPLICATIONS

This patent application claims the benefit of priority to the following U.S. Provisional Patent Application Ser. No. 63/350,010, filed Jun. 7, 2022, entitled “System and Method for Training Artificial Intelligence Tradable Assets to Replicate a Specific Person or Group of People.” The above application is hereby incorporated by reference in its entirety as if fully set forth herein.

### FIELD OF INVENTION

This invention relates to the field of computer systems and virtual reality. It pertains to the utilization of artificial intelligence technologies within the metaverse. Systems and methods are disclosed to train an asset to replicate a specific person in the metaverse.

### BACKGROUND AND SUMMARY OF INVENTION

The metaverse represents a rapidly evolving environment where individuals interact, socialize, and engage in a variety of activities using virtual reality technology. As the metaverse expands in scope and complexity, there is a need for advanced artificial intelligence (AI) systems that can enhance user experiences, facilitate interactions, and provide intelligent services within this virtual realm. A trained non-fungible asset of a person or any data or information that represents the profile of the person (hereinafter referred to as bots) is an AI driven computer program, optionally trained using data, that simulates human game play in any game and/or system using textual and/or transactional and/or game play and/or bodily motion and/or VR generatic haptics data and/or VR/AR/Metaverse collected contextual data that replicates the user behavior in an enclosed system.

Games often incorporate both player-controlled characters and bots (commonly known as non-player characters, software-controlled virtual entities, commonly referred to as computer players, AI units, AI characters, non-player characters, or computer-simulated game agents). Traditionally, players interact with their player-controlled character through input devices like game controllers, keyboards, mice, touch screens, or other means. Multiplayer games allow multiple players located remotely to collaborate as a team or compete against each other. Non-player characters are programmed to respond to in-game stimuli, such as actions or events involving other non-player characters or player-controlled characters, in a manner that emulates realistic human-like behavior. Typically, during game play, the behavior of a non-player character is preprogrammed as part of the process.

Bots are often implemented in game systems to act as computer-simulated game agents (e.g., as enemy, ally, background character, and/or agent in the game). The invention contemplates training of bots using game play and simulated game data from various users, and previously trained bots. The training of these bots usually aims to optimize and/or maximize how well the bots (game agents) play the game. As such, the bots in these implementations represent a generic, normalized version of the personalities and attributes of the entire sampled user base or these implementations represent a generic and normalized version of the simulations, and simulations' static (non-varying across training stages) distribution. The invention outlined is a novel framework for a tradable representation of users within an AI driven metaverse company or any other computer medium. The platform incorporates a user interface for agents that enable them to serve as artificial trainers in real-time.

### BRIEF DESCRIPTION OF THE DRAWINGS

Non-limiting and non-exhaustive examples are described with reference to the following figures and exhibits (incorporated by reference herein).

FIG. 1 depicts an exemplary non-fungible digital asset or bot

FIG. 2 depicts a high-level flowchart illustrating a method for training artificial intelligence assets

FIGS. 3A and 3B depict exemplary embodiments connecting the real world with the metaverse

FIG. 4 depicts an exemplary embodiment of the system of the invention

FIG. 5 depicts an exemplary embodiment of statistical feedback and training of artificial intelligence assets

FIG. 6 depicts an exemplary embodiment of a user interface

FIG. 7 depicts an exemplary embodiment of a user environment restricting or enhancing the bots capabilities

FIG. 8 depicts an exemplary embodiment of mutating the data

### DETAILED DESCRIPTION

Developments in AI software and hardware are expected to increase automation, reduce the labor demand, enhance efficiency, and drive masses towards the metaverse. The invention outlined in this application is a novel AI system designed to operate within the metaverse. The system utilizes a combination of machine learning algorithms, natural language processing, computer vision, and other AI techniques to provide a range of functionalities. Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete and will fully convey the scope of the aspects to those skilled in the art. Aspects may be practiced as methods, systems or devices. Accordingly, aspects may take the form of a hardware implementation, an entire software implementation or an implementation combining software and hardware aspects. The following detailed description is, therefore, not to be taken in a limiting sense.

### Non Limiting Definitions

The terms “a”, “an” and “the” are intended to include the plural forms as well, unless the context clearly indicates otherwise.

The terms “comprises” and/or “comprising,” when used in this specification, specify the presence of stated features, steps, operations, elements, and/or components, but do not preclude the presence or addition of one or more other features, integers, steps, operations, elements, components, and/or groups thereof.

The term “blockchain” is a distributed database that keeps a continuously growing list of data records. Each data record is protected against tampering and revisions. Blockchains are used with public ledgers of transactions, where the record is enforced cryptographically. The term blockchain covers a public ledger of all transactions of a blockchain-based cryptocurrency. One or more computing devices may comprise a blockchain network, which may be configured to process and record transactions as part of a block in the blockchain. Once a block is completed, the block is added to the blockchain, and the transaction record thereby updated. In many instances, the blockchain may be a ledger of transactions in chronological order or may be presented in any other order that may be suitable for use by the blockchain network. In some configurations, transactions recorded in the blockchain may include a destination address and a currency amount, such that the blockchain records how much currency is attributable to a specific address. In some instances, additional information may be captured, such as a source address, timestamp, etc.

Blockchain includes a plurality of blocks of digital data. Each block includes content data, a timestamp, and a cryptographic digital signature, providing source-authentication of the content data. The timestamp may be supplied by a distributed-computing service executing on peer-to-peer network. In some examples, the timestamp may be encrypted. Each block also includes, with the exception of genesis block, a cryptographic hash of the content data of a previously written, antecedent block. The hash links each block to its antecedent, defining the blockchain structure. Embodiments of the invention can be associated with the blockchain of any one or more cryptocurrencies.

The term “hash function” is a mathematical algorithm that turns an arbitrarily large amount of data into a fixed-length size. The same hash will always result from the same data but modifying the data by even one bit will completely change the hash. The values returned by the hash function are called a “hash.”

The term “public ledger” is a publicly accessible listing of transactions for the distributed database or blockchain. The term “private ledger” is a privately accessible listing of transactions for the distributed database or blockchain. Some virtual ledgers may be hosted on a centralized computer-memory system maintained by an authority. A virtual ledger may be hosted on a decentralized computer-memory system of a network of substantially independent computer devices. A virtual ledger hosted in this manner may take the form of a blockchain residing on a peer-to-peer network.

The term “transaction account” covers a financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, Metamask, Coinbase, etc.

An embodiment of the term “metaverse” is a virtual-reality space in which users can interact with a computer-generated environment and other users that can optionally be accessed from a VR set as well as a conventional computer or phone. Embodiments of the invention are not limited to a single metaverse. Non-limiting examples of metaverses are Decentraland or Sandbox. Embodiments of the invention can be in one or more metaverses, simultaneously, sequentially, or otherwise. Another embodiment of metaverse is any game or closed economy environment that exists virtually or physically, that can also expand and have free agent or agents making decisions simultaneously or sequentially.

The term “metadata” is a set of data that describes and gives information about other data (or NFT).

The term “game” is any high fidelity replication of any scenario that requires an agent to make decisions. While the word “game” is used extensively throughout this application, embodiments of the invention have broad applicability to any industry where users 200 can be replicated virtually (i.e., sports, car-racing, casino games, cooking, performance arts, chess, backgammon, professional/corporations, schools, etc.). For example, a doctor who is virtually operating on a patient, and a lawyer who is virtually drafting a legal document, can be trained according to embodiments of the invention. Skilled artisans would appreciate the broad applicability and industry of tradable artificial intelligence assets that can be trained according to embodiments of the invention. Any scenario and/or system that lacks a clear win/lose metric but requires the agent to make decisions nonetheless such as what to wear, which direction to walk also is considered to be a game for the context of this application.

This disclosure is directed to a computer-based system and related network method to train a tradable asset on a blockchain or other form of virtual ledger or marketplace to embody a representation of a real-world asset (i.e., a specific person, data about specific person and/or a model to represent the specific person). Real-world assets refer to objects, entities, or elements that exist in the physical world and can be integrated into the virtual world to enhance realism, immersion, and gameplay experiences. The invention contemplates the possibility of eternal living of real-world asset(s) within the metaverse. The invention contemplates generations of real-world asset(s) existing simultaneously within the metaverse. The invention can be described in modules.

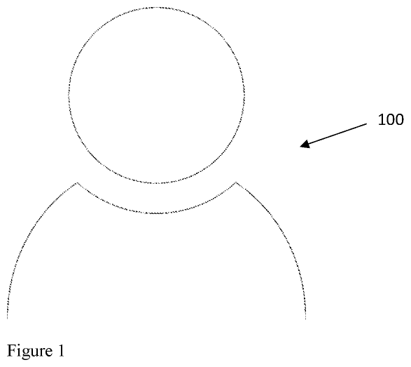

FIG. 1 depicts an exemplary tradable asset 100 (also described herein as “bot”), according to an embodiment of the invention. In this disclosure, an “asset” is a thing of value that can be owned by or otherwise associated with a person or group of people; the term “owner” refers to the party or user to which an asset is associated, whereas “client” refers to any party that deploys and/or maintains and/or subscribes to a virtual ledger for the purpose of tracking an asset. A client may be a person, a company, an organization, or a government, as examples. An asset can be created, redeemed, and, in some cases, exchanged between owners. An asset may be “transferable” or “non-transferable,” “expirable” or “non-expirable,” and so on. Generally, a ledger (public or private) may be used to track asset transactions. In the implementations disclosed herein, asset transactions are tracked on a virtual ledger—i.e., a digital data structure stored in a computer-memory system. By extending appropriate read and write access to the data structure, the various transactions of any asset represented on the virtual ledger may be recorded and verified.

A real-world asset may be characterized by numerous behaviors, such as physical interactions, environmental responses, realistic movements, and dynamic characteristics. Real-world assets can also exhibit behaviors influenced by the environment or player interactions.

According to embodiments of the invention, assets may be non-fungible. Non-fungible assets can also be digital or virtual, such as a non-fungible tokens (“NFTs”), which are cryptographic assets on a blockchain with unique identification codes and metadata that distinguish them from each other. NFTs, tracked on a virtual ledger (e.g., blockchain), may differ with respect to the behaviors that govern asset creation, exchange, and/or redemption. In general, a virtual ledger where each unit of an asset is represented by some form of digital token is programmed to endow that token with a set of behaviors appropriate for the asset it represents. By way of example, “fungible” behavior enables an asset to be exchanged with other assets of the same class. Every unit of a given denomination of currency (e.g., a dollar) is fungible, because it has the same value as every other unit of the same denomination. A property title, by contrast, is “non-fungible” because its value depends on the size, location, and other aspects of the specified property.

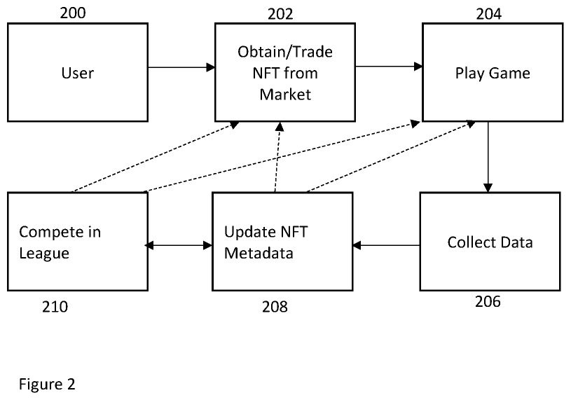

FIG. 2 depicts a high-level flowchart illustrating a method for training artificial intelligence assets. For example, an embodiment of the invention can be implemented in the virtual gaming industry. A user 200 can obtain a bot 100, such as an NFT, or other tradable asset attached to the data representing the bot, from the digital market 202. A user 200 can play a game 204 using the acquired bot 100. In embodiments of the invention, the brain and body of the bot 100 may be acquired separately, and both brain and body of the bot 100 may be required to play the game. The user 200 trains the bot 100 by playing against one or more players (users and/or computer bot(s) (e.g., as enemy, ally, background character, and/or agent in the game)). In embodiments of the invention, the bot 100 is trained by mimicry. This can include imitation learning and/or other reinforcement learning algorithms and/or supported by other statistical frameworks wherein the bot 100 learns to play from the user's 200 individualized game play. In embodiments of the invention, skilled artisans would appreciate that any algorithm that can carry out a task, is trainable, and can be retrained, suffices for the purposes of the invention to describe an agent. For example, large language models fine tuned to carry out one or more tasks can be considered a suitable agent. In embodiments of the invention, the bot 100 is trained to play according to those skilled in the relevant area, i.e., replicas of famous gamers, presently or historical. For example, if the game 204 was a boxing match, the user's 200 bot 100 can be trained to box according to one or more, or combination thereof, famous boxers in history. For example, if the game 204 was a heart transplant surgery, the user's 200 bot 100 can be trained to box according to one or more, or combination thereof, of renowned cardiologists. Skilled artisans would appreciate the various types of relevant game play according to embodiments the invention.

With each game, the user 200 obtains feedback and/or training data 206 on the bot's 100 performance (e.g., as enemy, ally, background character, and/or agent in the game). According to embodiments of the invention, data 206 can be a JSON file, tabular linear input, visuals, audio files, annotation files, XML files, dictionaries or any data structure of equivalent form that captures any and/or every aspect and/or state of the game and/or system, or any way to represent game play. According to embodiments of the invention, data 206 can be stored in an NFT metadata or a database. According to embodiments of the invention the data 206 can be stored in an NFT metadata that has a unique identifier that points at a growing dataset within a database. Skilled artisans would be aware of equivalent methods of storing data.

This training data 206 is used to update the metadata 208 of the bot 100. For example, in embodiments of the invention, the user 200 obtains a data point 206 for each game played. In embodiments of the invention, the user 200 obtains multiple data points 206 for each game played. In certain embodiments of the invention, the user 200 can play an unlimited number of games 204 with the bot 100, or play live games against other users (human opponents) in the server, to collect data 206 that will be used to train the bot that will replicate the user 200's game play and any other aspects of personality, character, strategy, to store in the training database 406 associated with the bot 100's metadata 208. In turn, the trained bot 100 will play against other bots and users, collecting unlimited amounts of data 206 on the bot's 100 performance with other game agents and/or against its various opponents for the user 200 to iteratively train the bot 100 to become better at the task at hand. In embodiments of the invention, the user can delete the data that the feedback show to be the “bad apple” training data for the bot 100 generated by the user 200 at an earlier time. Feedback data 206 from the bot's 100 metadata 208 can be erased, manipulated and removed before or after the metadata 208 is updated. In embodiments of the invention, skills and abilities (i.e., the right to delete data), clothing, and other customizations can be purchased by the user 200. In embodiments of the invention, the trained bot 100 can compete in a league with game agents and/or against opponents in an unlimited number of games 204.

According to embodiments of the invention, users 200 can monetize their game play and efforts through the market 202. For example, according to embodiments of the invention, a trained bot 100 can be traded or rented in the market 202 for personal or commercial reasons. Embodiments of the invention contemplate renting or purchasing, for example, Lionel Messi for a soccer tournament, Barack Obama for a political dining event, and/or Dave Chapelle for a private comedy event and/or invite your great grandfather for a game of chess long after his passing According to embodiments of the invention, a single real-world individual can be replicated virtually in a bot 100, complete with all identifying features of that individual in the real world. According to embodiments of the invention, a specific person can have numerous bots 100 replicating them. The virtual or physical body of the specific person can be changed, swapped or altered in embodiments of the invention. Embodiments of the invention contemplate an ability to verify authenticity of personas represented by bots 100. Embodiments of the invention also contemplate on versions where the final model is a combination of multiple individual models or a single model that can be applied to represent the entirety of the user.

According to embodiments of the invention, users 200 can add training data 206 to a bot 100 purchased from the market 202. This is equivalent of being it's “coach”. For example, if a user 200 purchases a bot 100 from the market 202 that is already skilled at boxing, the user 200 can train the bot 100 with skills or data 206 that derive from the user 200. According to embodiments of the invention, bots 100 can be trained by multiple users through change of ownership, either directly or through the market 202. According to embodiments of the invention, a user 200 can train a countless number of bots 100 and/or users 200 can train a countless number of bots 100 with the same skill. For example, a car company like Tesla can purchase a user's 200 (or an unlimited number of users' 200) bots 100 that have been trained to simulate how the specific users drive their cars. The community can then sell the data to Tesla, and create community funds.

In embodiments of the invention, the game 204 will be open source. In other embodiments, the game 204 will be proprietary as generated by a developer. According to embodiments of the invention, changes to the game can be governed by a Decentralized Autonomous Organization (DAO). In other embodiments, the changes are made directly by the developer. The game 204 can generate new untrained bots 100 to be purchased by users in the market 202. According to embodiments of the invention, the timing and circumstances of the new bot 100 generation (releasing them on the market place 202) can be strategized to reduce inflation of the price of the bot 100 and/or hedge against depreciation of the bot 100 asset within the game economy

Embodiments of the invention include human-in-the-loop (HITL) interactive simulation. Human-in-the-loop allows the user to change the outcome of an event or process. HITL is effective for the purposes of training because it allows the trainee to immerse themselves in the event or process, and, in embodiments of the invention, contributes to a positive transfer of acquired skills into the real world. Because the bot 100's artificial intelligence systems can be continually trained, their performance can improve over time. Thus, the current subject matter can route tasks based on machine performance, which can be represented by a confidence metric and/or success in accomplishing a task produced by the artificial intelligence system. As the artificial intelligence component is trained on more real-world data, the artificial intelligence component becomes more accurate. Thus, the relative processing burdens between the artificial intelligence component and the human intelligence component is dynamic and can vary over time.

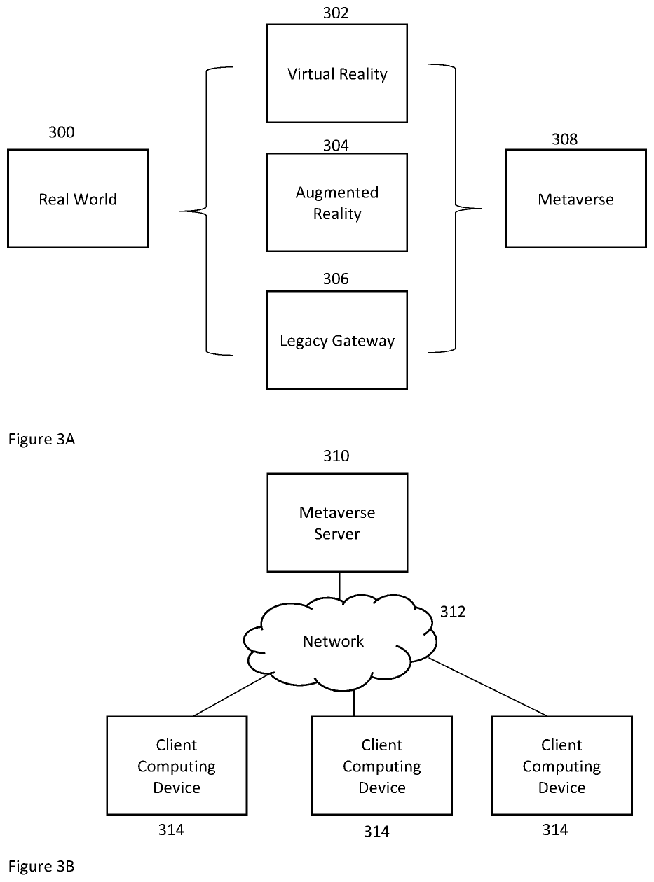

FIG. 3A is a schematic depicting an exemplary embodiment of how the physical world 300 can connect to the metaverse 308 via, for example, virtual reality 302, augmented reality 304, and legacy systems 306, such as a mobile or computing device. Skilled artisans would appreciate the many devices connecting the physical world 300 to the metaverse 308. Each one of these systems will allow certain levels of input by the user.

FIG. 3B is a schematic describing an embodiment which facilitates processing connections in a metaverse server. An exemplary metaverse server 310 serves a virtual world simulation, or metaverse 308, through a software application that may be stored and executed on a computer system (302, 304, 306, collectively 314). The illustrated computer network system includes a client computer 314, a metaverse server 310, and a network 312. The computer network system may interface a system user and a metaverse server 310 according to the interface operations of the client computer 314. Although the depicted computer network system is shown and described herein with certain components and functionality, other embodiments of the computer network system may be implemented with fewer or more components or with less or more functionality. For example, some embodiments of the computer network system include a plurality of metaverse servers 308 and a plurality of networks 312. Additionally, some embodiments of the computer network system include similar components arranged in another manner to provide similar functionality, in one or more aspects. The client computer 314 manages the interface between a system user and the metaverse server 310.

In one embodiment, the client computer 314 is a desktop computer or a laptop computer. In other embodiments, the client computer 314 is a mobile computing device that allows a user to connect to and interact with a metaverse. In some embodiments, the client computer 314 is a video game console. The client computer 314 is connected to the metaverse server 308 via a local area network (LAN) or other network 312. The metaverse server 308 hosts a simulated virtual world, or a metaverse, for a plurality of client computers 314. In one embodiment, the metaverse server 308 is an array of servers. In one embodiment, a specified area of the metaverse is simulated by a single server instance, and multiple server instances may be run on a single metaverse server 308. In some embodiments, the metaverse server 308 includes a plurality of simulation servers dedicated to physics simulation in order to manage interactions and handle collisions between characters and objects in a metaverse. The metaverse server 308 also may include a plurality of storage servers, apart from the plurality of simulation servers, dedicated to storing data related to objects and characters in the metaverse world. The data stored on the plurality of storage servers may include object shapes, avatar shapes and appearances, audio clips, metaverse related scripts, and other metaverse related objects. The network 312 may communicate traditional block I/O, for example, over a storage area network (SAN). The network 312 may also communicate file I/O, for example, using a transmission control protocol/internet protocol (TCP/IP) network or similar communication protocol. In some embodiments, the storage system includes two or more networks 312. In another embodiment, the client computer 314 is connected directly to a metaverse server 308 via a backplane or system bus. In one embodiment, the network 312 includes a cellular network, other similar type of network, or combination thereof.

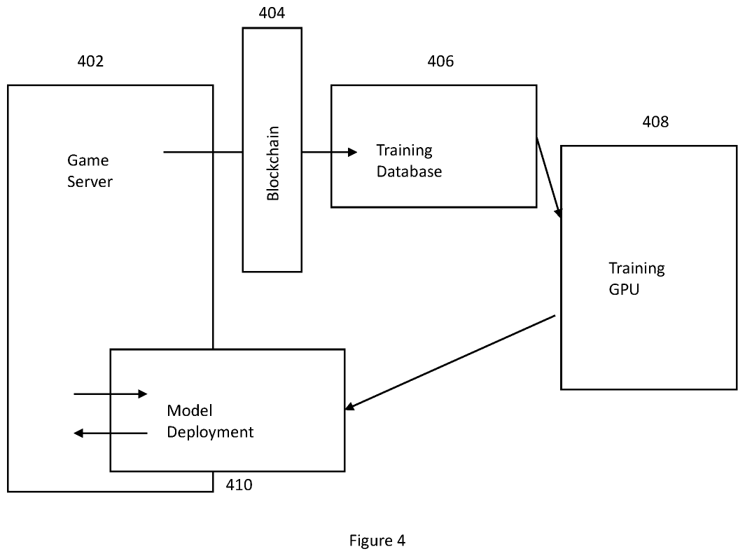

FIG. 4 depicts an exemplary embodiment of the system and method of the invention depicting how a bot 100 is trained. According to embodiments of the invention, a user 200 plays a game 204 in the game domain 402, which generates data 206 for the bot 100. This data 206 is transmitted over the blockchain 404 to a training database 406. The game domain 402 has its own server. The database 406 is stored in any storage device (local, virtual/cloud) with/without a server and graphics processing unit (GPU) bucket 408. The blockchain 404 can be associated with any cryptocurrency. The training GPU 408 is used to train the bot 100 to create a model updated with the data 206 associated with the bot 100's game play. According to embodiments of the invention, an infinite number of games can be played, and the dataset and/or models are updated with each game play. The trained model is then stored in 410, which may be in the local database of the user or the cloud to be uploaded/downloaded to the game server during game play.

According to embodiments of the invention, the model, stored in any storage device, constantly communicates with the game. While one or more games are being played in the game domain 402, the model is continuously reacting to the game play; each game state is being sent to the model in storage 410, the model decides the next action, and then sends that action to the game domain 402 as part of model deployment 410.

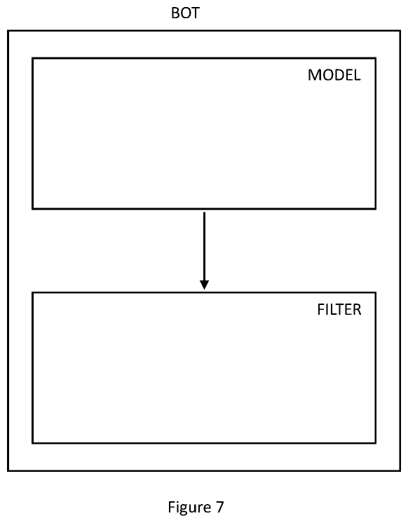

According to embodiments of the invention, the model will behave within the constraints of the environment of the user 200 who owns the bot 100 associated with such model as shown in FIG. 7. In embodiments of the invention, a user's 200 limits might prevent a user 200 from unlocking all the capabilities of a purchased bot 100 associated with an advanced model. For example, a user 200 seeking to win a cooking competition might buy a bot 100's model associated with Gordon Ramsay's cooking skills, but be limited by a filter based on the user 200's own associated limitations. In embodiments of the invention, a user 200's limits might enhance a user 200's ability to unlock all of the capabilities of a purchased bot 100 associated with an advanced model. For example, a user 200 seeking to win a cooking competition might buy the bot 100's model associated with Gordon Ramsay's cooking skills, and be further advantaged by a filter based on the user 200's own associated enhancements. In other words, according to embodiments of the invention, models associated with bots 100 can react differently based on the identity of the user 200 that acquires the bot 100 and associated model. According to embodiments of the invention, unlocking capabilities of a user 200 can be earned or purchased from the market 202.

According to embodiments of the invention, the model is in the bot 100's mind, and is making decisions for the bot 100 within the enclosed game domain 402. According to embodiments of the invention, the model might get read in-memory during the game but is eventually stored in the cloud. According to embodiments of the invention, the bot 100's data and trained model can be traded. According to embodiments of the invention, the bot 100's body and the mind are separable and optionally separably traded. According to embodiments of the invention, and as discussed herein, game play can occur in one or more metaverses.

According to embodiments of the invention, the user 200 can train the bot 100 and/or model using a keyboard, mouse, computer interface, touch enabled interface, haptic interface, physical input, or recordings of video, voice, taste, or smell. Skilled artisans would be aware of the various sensory attributes that has associated data that can be used to train the bot 100 and/or model.

It is likely that multiple computing systems or devices will be utilized to implement the method and system in accordance with embodiments of the invention. Each computing system may include a processing unit, a peripheral interface, a user input interface, a system bus, a system memory, a network interface, a memory interface, and any other components. Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM).

A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, receipt management components, other program modules, and program data.”

As described above, embodiments of the system of the invention and various processes of embodiments are described. The system of the invention or portions of the system of the invention may be in the form of a “processing machine,” i.e., a tangibly embodied machine, such as a general purpose computer or a special purpose computer). As used herein, the term “processing machine” is to be understood to include at least one processor that uses at least one memory. At least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a microcontroller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer. The computer understands the machine language.

Any suitable programming language may be used in accordance with the various embodiments of the invention, for example, Python, Java, C++, SQL, PySpark. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, which enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

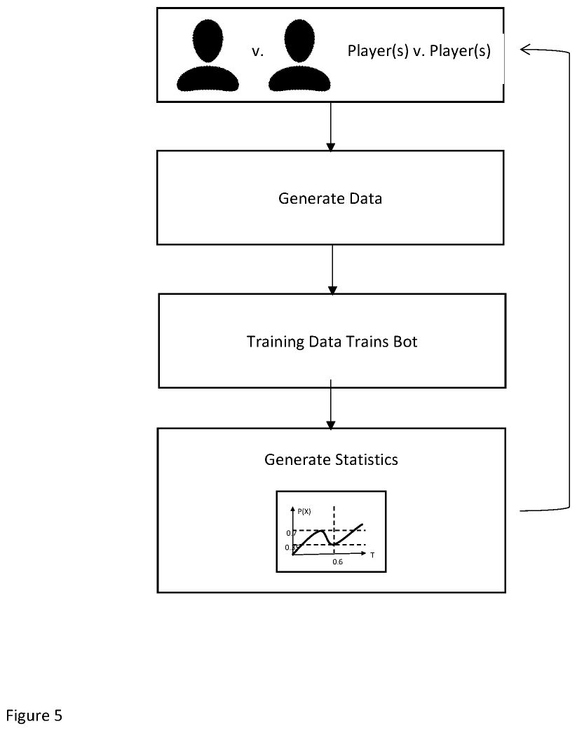

FIG. 5 is an exemplary embodiment of statistical feedback and training of artificial intelligence assets. In this embodiment, a user 200 plays against another user 200 to generate training data 206 from game play 204. The training data 206 can be displayed on a user interface, and be used to train a second bot 100. The second bot 100 plays against a third bot 100 to generate training data 206 from game play. This training data 206 can be displayed on a user interface, and be used to train a fourth both 100. A user 200 can play an unlimited number of games 204 with the bot 100

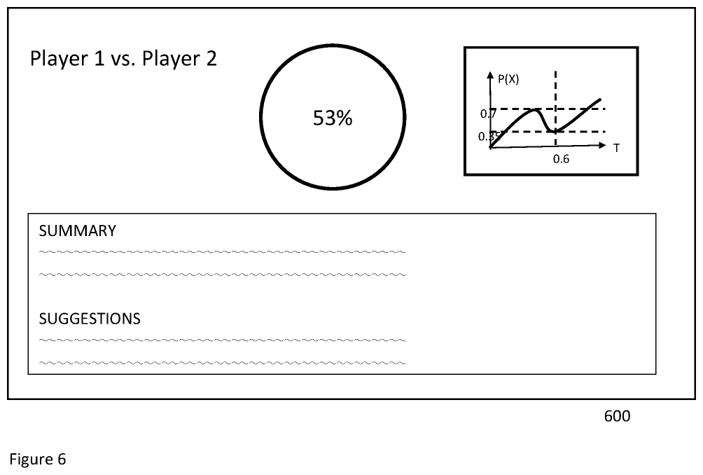

According to embodiments of the invention, the data 206 generated from game play (i.e., user against user, bot against bot) as described herein, can be analyzed. For example, data 206 can show that in the second minute of a game, a bot 100 made a decision that caused the probability of winning to be reduced 50%. For example, in accordance with embodiments of the invention, data collected that can be analyzed include, but are not limited to, screen captures or video replays of game play, number of games played, time to finish game play, how a bot 100's moves impact game outcome, policy network, and set of moves available, which move(s) had what probability of being executed, competitor's game play, simulation data against the competitors. Data collected can include: player performance metrics, such as, score, kills/deaths, accuracy, completion time, achievements/quests, and/or win/loss ratio: gameplay behavior metrics, such as, playtime, sessions, exploration, interactions, and/or choices; social and community metrics, such as leaderboard rankings, player-versus-player performance, number of in-game messages, chats, and/or voice interactions; economy and resource management metrics, such as, virtual economy and/or resource management; game balance and tuning metrics such as heatmaps, engagement metrics, and/or difficulty adjustments; and user experience metrics, such as, surveys and feedback, abandonment rates, and/or retention rates. Skilled artisans would appreciate the various statistics that can be extracted from data 206 generated from game play in the many types of games contemplated by the invention. The data 206 can be depicted graphically, numerically, pictorically, or otherwise, on a user interface 600, as shown in FIG. 6.

The user interface 600 can optionally include, for example, replays and/or screen captures (i.e., screenshots, videos, or other pictorial display) of the game play. According to embodiments of the invention, the user interface 600 can display analyzed data that shows any number of metrics obtained in the database 406. Skilled artisans would appreciate the various data points generated in the database for any game played. For example, the user interface 600 can isolate and show the moves the bot 100 makes that reduce its ability to win a game. According to embodiments of the invention, a user 200 can manage (i.e., edit, erase, or manipulate) the data in the database 406. For example, a user 200 can erase the data 206 associated with a 50% reduction in winning capacity that is from a previous training data point generated by a human (user 200). According to embodiments of the invention, this erasure, manipulation or editing, can be done with or without earning or purchasing the right in the market 202 by the user 200. In embodiments, the right to erase, edit, or manipulate the data is limited or eliminated. According to embodiments of the invention, screenshots (video or other pictorial representations) associated with such a result can be correlated and displayed for the user 200 on the user interface 600. According to embodiments of the invention, the user interface 600 can display data 206 and relevant factors summarizing the game. In embodiments of the invention, the user interface 600 displays analyzed suggestions on moves for the bot 100.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

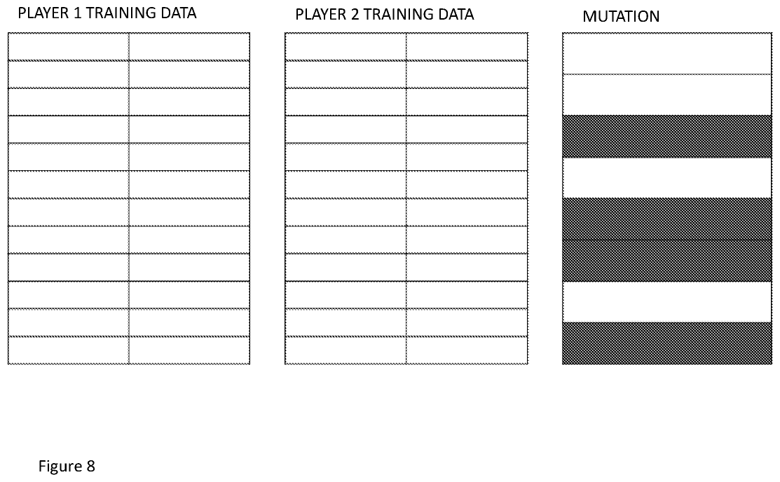

FIG. 8 depicts an exemplary embodiment of mutating the data. According to embodiments of the invention, datasets or models can be merged into a mutated dataset or model. According to embodiments of the invention, the strengths and attributes of a single dataset or model can be combined with the strengths and attributes of a second dataset or model into a third, or mutated, dataset or model for game play. The datasets can be in related or unrelated fields. For example, Gordon Ramsay's dataset and/or model can be merged with Barack Obama's dataset and/or model for a combined political chef dataset and/or model. The ability to mutate data and/or models can be purchased from the market 202.

According to embodiments of the invention, the bot 100 can be replicated from the virtual world in the real-world. Embodiments of the invention can capture agent input to augment artificial intelligence. The platform incorporates a user interface for agents that enable them to serve as artificial trainers in real-time.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

Aspects of the present disclosure are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system for training artificial intelligence assets, comprising:
a digital market module configured to facilitate acquisition of a bot from a digital market;
a game module configured to enable a user to play a game using the acquired bot;
a training module configured to train the bot through game play against one or more players, wherein the bot is trained using mimicry; and
a feedback module configured to obtain training data on the bots performance in the game, wherein the training data includes characteristics of the game play and is stored in metadata or a database.

2. The system of claim 1, wherein the feedback module generates data on at least one of player performance, gameplay behavior, social and community, economy and resource management, game balance and tuning, and user experience metrics.

3. The system of claim 1, further comprising a data update module configured to enable the user to delete, erase, manipulate, or remove the bot's training data from the metadata or database.

4. The system of claim 1, further comprising a customization module configured to offer customizations such as skills, abilities, clothing, and other personalizations for purchase by the user from the market.

5. The system of claim 1, further comprising a league module configured to allow the trained bot to compete in a league with other players.

6. The system of claim 1, wherein the bot can be traded or rented.

7. The system of claim 1, further comprising human-in-the-loop interactive simulation.

8. The system of claim 1, wherein the training data can be mutated.

9. A system for training a bot in a game domain, comprising:
a user interface configured to enable a user to play a game within a game domain and generate data associated with the bot's game play;
a blockchain configured to receive and transmit the data associated with the bot's gameplay;
a training database stored in a storage device, wherein the training database is updated with the data received over the blockchain;
a training GPU configured to train the bot using the data from the training database to create a model associated with the bot's game play;
a model database configured to store the trained model;
and a model deployment module configured to receive a game state from a game domain over a server, decide the next action based on the received game state, and send the next action to the game domain for model deployment over the server.

10. The system of claim 9, wherein the trained model can be mutated.

11. The system of claim 9, wherein the trained model's capabilities are unlocked.

12. The system of claim 9, wherein the bot can be traded or rented.

13. A method for training artificial intelligence assets comprising:
acquiring a bot from a digital market;
enabling a user to play a game using the acquired bot;
training the bot through game play against one or more players using mimicry; and
obtaining training data on the bot's performance in the game, wherein the training data includes characteristics of game play and is stored in metadata or a database.

14. The method of claim 13, wherein the training data comprises at least one of player performance, gameplay behavior, social and community, economy and resource management, game balance and tuning, and user experience metrics.

15. The method of claim 13, further comprising enabling the user to delete, erase, manipulate, or remove the bot's training data from the metadata or database.

16. The method of claim 13, further comprising enabling a user to purchase skills, abilities, clothing, and other personalizations from the market.

17. The method of claim 13, wherein the bot competes in a league with other players.

18. The method of claim 13, wherein the bot can be traded or rented.

19. The method of claim 13, further comprising human-in-the-loop interactive simulation.

20. The method of claim 13, wherein the training data can be mutated.
